(19) United States
(12) Patent Application Publication
(10) Pub. No.: US 2011/0304838 A1
(43) Pub. Date: Dec. 15, 2011

(54) EXPOSURE SYSTEM AND ADJUSTMENT METHOD THEREOF

(75) Inventors: Chun-Chieh Huang, Hsinchu City (TW); Yuan-Chin Lee, Hsinchu City (TW); Chin-Tien Yang, Taipei County (TW); Kuen-Chiuan Cheng, Kaohsiung City (TW); Shuen-Chen Chen, Taichung County (TW); Chih-Yu Chen, Hsinchu City (TW)

(73) Assignee: INDUSTRIAL TECHNOLOGY RESEARCH INSTITUTE, Hsinchu (TW)

(21) Appl. No.: 12/884,202

(22) Filed: Sep. 17, 2010

(30) Foreign Application Priority Data
Jun. 11, 2010 (TW) 99119091

(51) Int. Cl. G03B 27/54; G03B 27/32

(52) U.S. Cl. 355/68; 355/77

(57) ABSTRACT

An exposure system including a first laser light source, a second laser light source, a focusing module, an astigmatism generating element, and a photo detector, and an adjustment method thereof are provided. The first laser light source emits a first laser beam. The second laser light source emits a second laser beam. The focusing module includes a light converging unit disposed on transmission paths of the first laser beam and the second laser beam for projecting the first laser beam and the second laser beam onto a material. The material reflects at least a part of the first laser beam into a first reflective beam. The light converging unit and the astigmatism generating element are disposed on the transmission path of the first reflective beam. The photo detector is disposed on the transmission path of the first reflective beam from the astigmatism generating element.

### CROSS-REFERENCE TO RELATED APPLICATION

This application claims the priority benefit of Taiwan application serial no. 99119091, filed on Jun. 11, 2010. The entirety of the above-mentioned patent application is hereby incorporated by reference herein and made a part of this specification.

### BACKGROUND

1. Technical Field

The disclosure relates to an exposure system and an adjustment method thereof.

2. Description of Related Art

In a photolithography process of semiconductor technology, a quality of an exposure effect generally has a decisive influence on a follow-up fabrication process, and accordingly influences quality and yield of a semiconductor device or chip. In detail, in the conventional photolithography process, a light source irradiates a photomask, and a pattern on the photomask is projected to a photoresist layer on a wafer through a projection lens, so as to selectively expose the photoresist layer. Then, a patterned photoresist layer is formed through development. Thereafter, another conductive layer, an insulation layer or a semiconductor layer is patterned according to a shape of the patterned photoresist layer. Therefore, if an exposure quality is poor, the shape of the patterned photoresist layer is incorrect, so that a shape of the conductive layer, the insulation layer or the semiconductor layer is incorrect, which may lead to a poor quality of the semiconductor device or chip.

However, the above photolithography process is generally carried on in a dust free room, since otherwise the wafer is probably polluted by dust, and the dust can be adhered to the photomask, so that a correct exposure pattern cannot be projected on the wafer. In other words, exposure performed through the photomask is generally carried on under a low dust or a dust free environment, which may limit an application level of the exposure process. Moreover, usage of the dust free room increases equipment utilization, so that a relatively great factory space is occupied, and energy used for achieving the dust free environment is consumed.

Moreover, since an exposure machine using the photomask requires a space to accommodate the photomask, and the projection lens and optical paths also occupy some spaces, a size of the exposure machine is large, and a structure thereof is complicate, which may decrease a utilization convenience of the exposure machine.

### SUMMARY

An exemplary embodiment of the disclosure provides an exposure system, which is adapted to expose a material. The exposure system comprises a first laser light source, a second laser light source, a focusing module, a first astigmatism generating element, and a first photo detector. The first laser light source is adapted to emit a first laser beam. The second laser light source is adapted to emit a second laser beam, wherein a wavelength of the second laser beam is different to that of the first laser beam. The focusing module comprises a first light converging unit disposed on transmission paths of the first laser beam and the second laser beam for projecting the first laser beam and the second laser beam onto the material. The material is adapted to reflect at least a part of the first laser beam into a first reflective beam, and the first light converging unit is disposed on a transmission path of the first reflective beam. The first astigmatism generating element is disposed on a transmission path of the first reflective beam from the first light converging unit. The first photo detector is disposed on a transmission path of the first reflective beam from the astigmatism generating element and is electrically connected to the focusing module. The first photo detector is adapted to detect the first reflective beam, and generate an electric signal according to a detecting result, and the focusing module adjusts a distance between the first light converging unit and the material according to the electric signal.

Another exemplary embodiment of the disclosure provides an exposure system, which is adapted to expose a material. The exposure system comprises a laser light source, a focusing module, an astigmatism generating element, and a photo detector. The laser light source is adapted to emit a laser beam. The focusing module comprises a first light converging unit disposed on a transmission path of the laser beam for projecting the laser beam onto the material. The material is adapted to reflect at least a part of the laser beam into a reflective beam, and the first light converging unit is disposed on a transmission path of the reflective beam. None grating is disposed on the transmission path of the laser beam between the laser light source and the material. The astigmatism generating element is disposed on a transmission path of the reflective beam from the first light converging unit. The photo detector is disposed on a transmission path of the reflective beam from the astigmatism generating element and is electrically connected to the focusing module. The photo detector is adapted to detect the reflective beam, and generate an electric signal according to a detecting result, and the focusing module adjusts a distance between the first light converging unit and the material according to the electric signal.

Another exemplary embodiment of the disclosure provides an adjustment method of an exposure system. The method comprises following steps. A specimen is provided. A first laser light source of the exposure system emits a first laser beam, which is transmitted to the specimen through a light converging unit of the exposure system, wherein the specimen is adapted to reflect at least a part of the first laser beam into a first reflective beam, and the first reflective beam is transmitted to a first photo detector of the exposure system through the light converging unit and a first astigmatism generating element of the exposure system. Moreover, a quality of a first electric signal formed on the first photo detector by the first reflective beam is adjusted by adjusting a state of the first photo detector, and when the quality of the first electric signal is within a first tolerance range, a first control unit electrically connected to the first photo detector is locked. Moreover, a second laser light source of the exposure system emits a second laser beam, which is transmitted to the specimen through the light converging unit of the exposure system, wherein a wavelength of the second laser beam is different to that of the first laser beam. The specimen is adapted to reflect at least a part of the second laser beam into a second reflective beam, and the second reflective beam is transmitted to a second photo detector of the exposure system through the light converging unit and a second astigmatism generating element of the exposure system. Moreover, a second electric signal generated by the second photo detector after receiving the second reflective beam is adjusted by adjusting a state of the second photo detector, and it is confirmed whether the second electric signal is within a second tolerance range.

Another exemplary embodiment of the disclosure provides an exposure system comprising a grating. The grating is disposed on a transmission path of a laser beam, and is located between a laser light source and a material, wherein the grating diffracts the laser beam to form multi-order diffraction beams, and at least diffraction beams in the multi-order diffraction beams that have absolute values of order numbers being 0, 1, 2 and 3 cause an exposure reaction of the material.

In order to make the aforementioned and other features of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a structural schematic diagram of an exposure system according to an exemplary embodiment of the disclosure.

FIG. 2A is a three-dimensional view of an astigmatism generating element and a photo detector of FIG. 1.

FIGS. 2B-2D are diagrams illustrating variations of an astigmatism generating element of FIG. 1.

FIG. 3A is a diagram illustrating beam spots formed on a photo detector by a reflective beam of FIG. 1 in different focusing states.

FIG. 3B is a diagram illustrating an S-curve signal generated by a control unit 136 after receiving an electric signal of a photo detector 150.

FIG. 4A is a flowchart illustrating an adjustment method of an exposure system according to an exemplary embodiment of the disclosure.

FIG. 4B is a schematic diagram illustrating a specimen mentioned in FIG. 4A.

FIG. 4C is a schematic diagram illustrating an electric signal generated by a control unit.

FIG. 5A is a cross-sectional view of an actuator and a light converging unit of FIG. 1.

FIG. 5B is a three-dimensional view of an actuator and a light converging unit of FIG. 1.

FIG. 6 is a structural schematic diagram illustrating an exposure system according to another exemplary embodiment of the disclosure.

FIG. 7 is a structural schematic diagram illustrating an exposure system according to still another exemplary embodiment of the disclosure.

FIG. 8A is a structural schematic diagram illustrating an exposure system according to yet another exemplary embodiment of the disclosure.

FIG. 8B illustrates multi-order diffraction beams generated by a grating.

### DETAILED DESCRIPTION OF DISCLOSED EMBODIMENTS

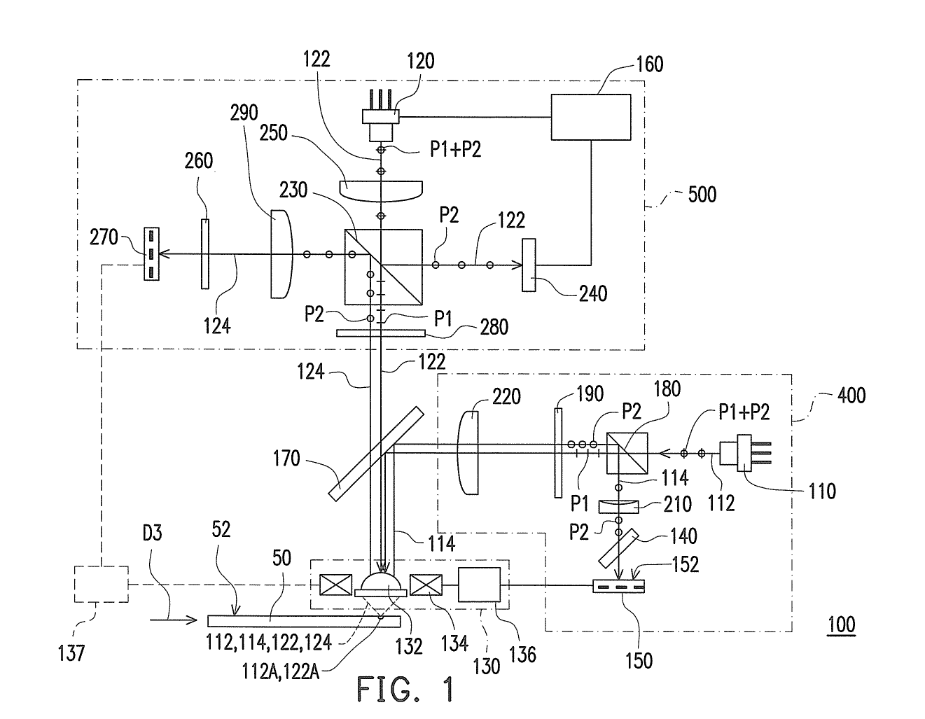

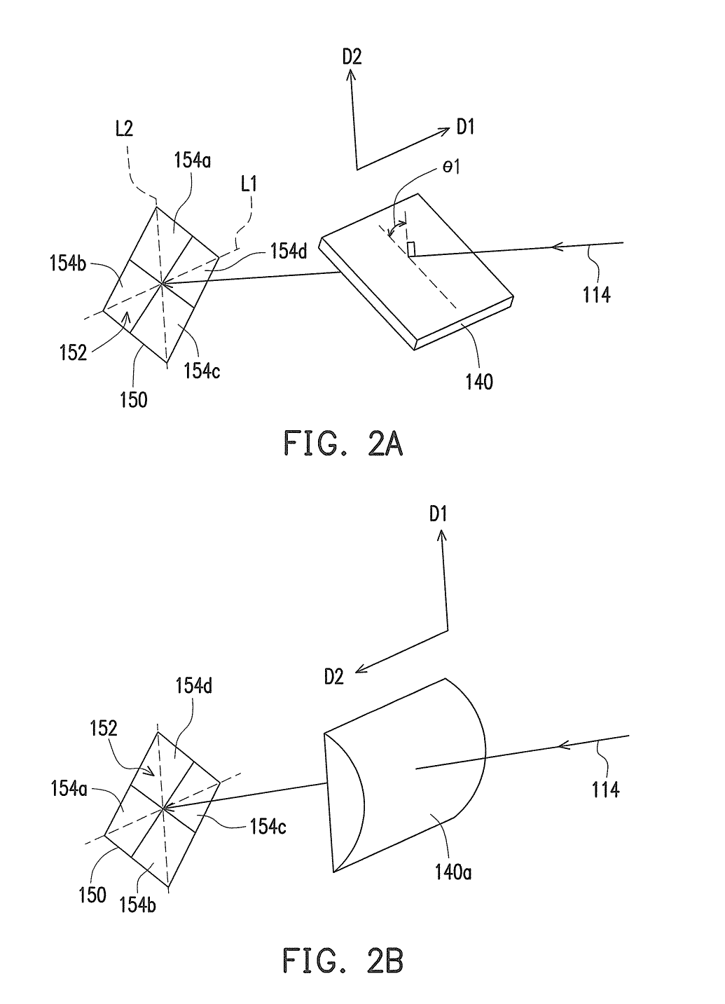

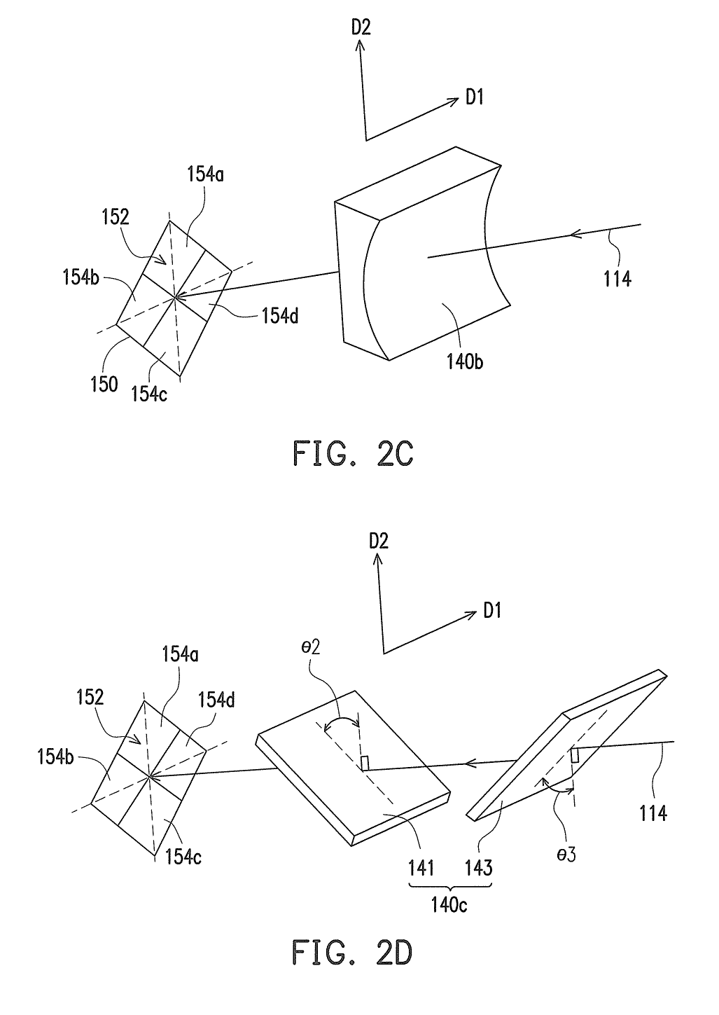

FIG. 1 is a structural schematic diagram of an exposure system according to an exemplary embodiment of the disclosure, FIG. 2A is a three-dimensional view of an astigmatism generating element 140 and a photo detector 150 of FIG. 1, and FIGS. 2B-2D are diagrams illustrating variations of the astigmatism generating element 140 of FIG. 1. Referring to FIG. 1 and FIG. 2A, the exposure system 100 of the present exemplary embodiment is adapted to expose a material 50. The exposure system 100 comprises a laser light source 110, a laser light source 120, a focusing module 130, an astigmatism generating element 140 and a photo detector 150. The laser light source 110 is adapted to emit a laser beam 112, and the laser light source 120 is adapted to emit a laser beam 122, wherein a wavelength of the laser beam 122 is different to that of the laser beam 112.

The focusing module 130 comprises a light converging unit 132. In the present exemplary embodiment, the light converging unit 132 is a lens, which is, for example, a focus objective lens, though in other exemplary embodiments, the light converging unit 132 can also be a lens group formed by a plurality of lenses. The light converging unit 132 is disposed on transmission paths of the laser beam 112 and the laser beam 122 for projecting the laser beam 112 and the laser beam 122 onto the material 50. The material 50 is adapted to reflect at least a part of the laser beam 112 into a reflective beam 114 (partial reflection or total reflection thereof is determined according to a characteristic of the material 50), and the light converging unit 132 is disposed on a transmission path of the reflective beam 114. The astigmatism generating element 140 is disposed on a transmission path of the reflective beam 114 from the light converging unit 132. In the present exemplary embodiment, the astigmatism generating element 140 is a light transparent plate oblique to the reflective beam 114. In detail, an angle (an acute angle) between the astigmatism generating element 140 and a plane perpendicular to the reflective beam 114 is θ1, and the angle θ1 is smaller than 90 degrees and is greater than 0 degree. However, in other exemplary embodiments, the astigmatism generating element can also be a cylinder lens. For example, in FIG. 2B, the astigmatism generating element 140a is, for example, a plano-convex lens. In FIG. 2C, the astigmatism generating element 140b is, for example, a plano-concave lens. Moreover, in FIG. 2D, the astigmatism generating element 140c comprises a light transparent plate 141 and a light transparent plate 143 which are oblique to the reflective beam 114, wherein an inclining direction of the light transparent plate 141 is inversed to that of the light transparent plate 143. In detail, an angle θ2 between the light transparent plate 141 and the plane perpendicular to the reflective beam 114 is smaller than 90 degrees and is greater than 0 degree, and an angle θ3 between the light transparent plate 143 and the plane perpendicular to the reflective beam 114 is smaller than 90 degrees and is greater than 0 degree.

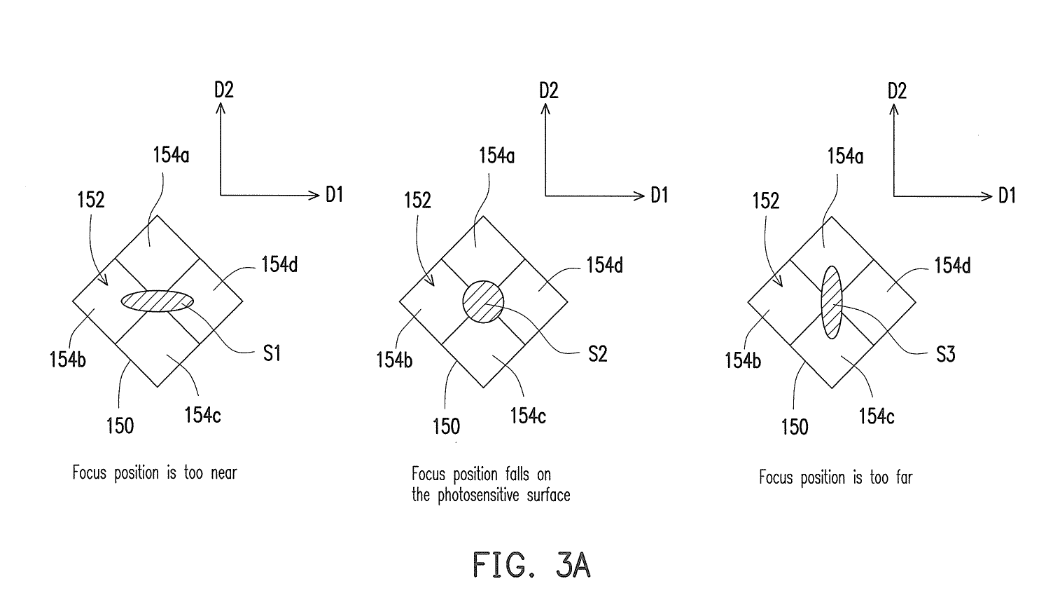

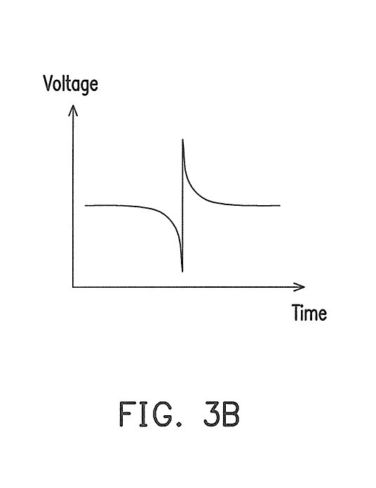

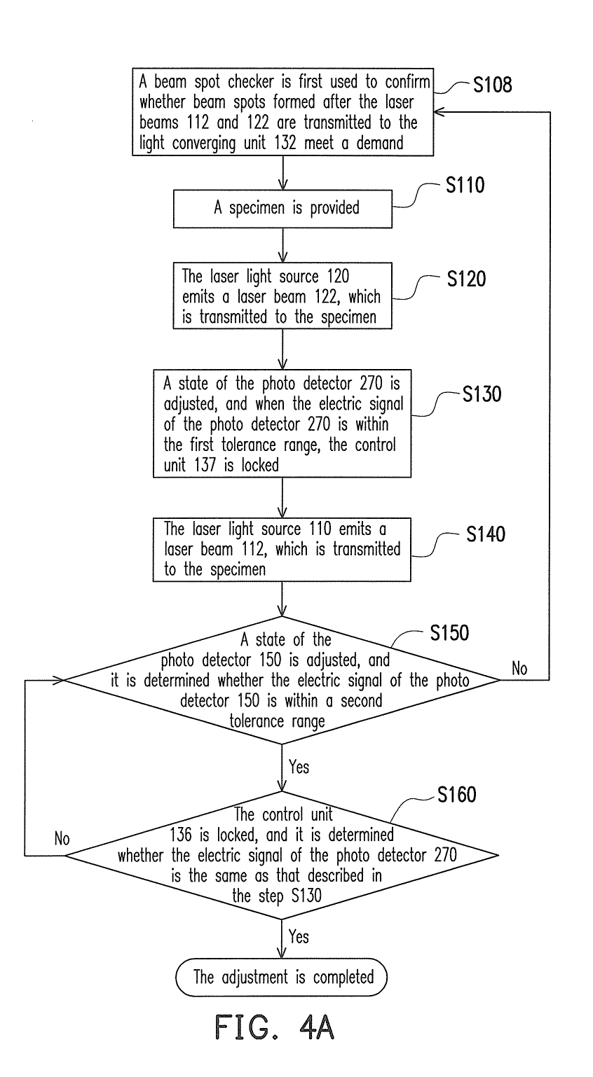

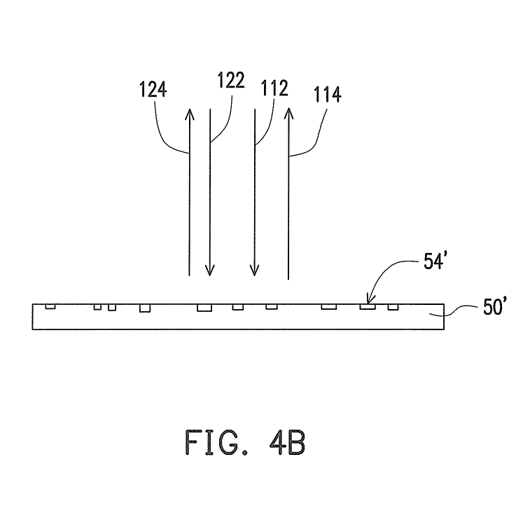

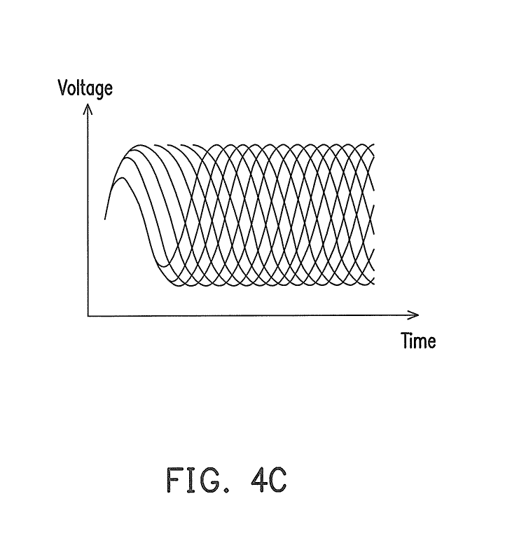

The photo detector 150 is disposed on a transmission path of the reflective beam 114 from the astigmatism generating element 140, and is electrically connected to the focusing module 130. The photo detector 150 is adapted to detect the reflective beam 114, and generates an electric signal according to a detecting result, and the focusing module 130 adjusts a distance between the light converging unit 132 and the material 50 according to the electric signal. In the present exemplary embodiment, the focusing module 130 comprises a control unit 136 electrically connected to the photo detector 150. The control unit 136 is, for example, a servo control unit. The control unit 136 is adapted to process and compute the electric signal transmitted by the photo detector 150, so as to generate an S-curve signal shown in FIG. 3B and an electric signal shown in FIG. 4C, wherein such electric signal is, for example, a reading signal (RF signal, i.e. a optical-to-electrical conversion signal) of a small region 54′ of a specimen 50′ of FIG. 4B, or a reading signal (RF signal) of a depressed or protruded small region on a surface 52 of the material 50. It should be noticed that the S-curve signal and the electric signal (for example, the RF signal) are not limited to have waveforms shown by an oscilloscope, which can also be presented by digital data or other suitable approaches as an application environment is changed. Moreover, the photo detector 150 is, for example, a photo detector integrated circuit (FDIC).

FIG. 3A is a diagram illustrating beam spots formed on the photo detector 150 by the reflective beam 114 of FIG. 1 in different focusing states, and FIG. 3B is a diagram illustrating the S-curve signal generated by the control unit 136 after receiving the electric signal of the photo detector 150. Referring to FIG. 1, FIG. 2A, FIG. 3A and FIG. 3B, in the present exemplary embodiment, the photo detector 150 comprises a photosensitive surface 152, and the photosensitive surface 152 comprises a first photosensitive area 154a, a second photosensitive area 154b, a third photosensitive area 154c and a fourth photosensitive area 154d, wherein the first photosensitive area 154a is located opposite to the third photosensitive area 154c, and the second photosensitive area 154b is located opposite to the fourth photosensitive area 154d. The first photosensitive area 154a is located adjacent to the second photosensitive area 154b and the fourth photosensitive area 154d, and the third photosensitive area 154c is located adjacent to the second photosensitive area 154b and the fourth photosensitive area 154d.

When a focus of the reflective beam 114 falls between the photosensitive surface 152 and the astigmatism generating element 140 (i.e. a focus position is too near), through the astigmatism generating element 140, a sum of energy projected to the first photosensitive area 154a and the third photosensitive area 154c by the reflective beam 114 is less than a sum of energy projected to the second photosensitive area 154b and the fourth photosensitive area 154d by the reflective beam 114. In detail, in the present exemplary embodiment, the second photosensitive area 154b and the fourth photosensitive area 154d are disposed on a straight line L1 substantially parallel to a first direction D1 (shown in FIG. 2A), and the first photosensitive area 154a and the third photosensitive area 154c are disposed on a straight line L2 substantially parallel to a second direction D2, wherein the first direction D1 is substantially perpendicular to the second direction D2, and the first direction D1 and the second direction D2 are substantially perpendicular to the reflective beam 114. Moreover, in the present exemplary embodiment, the astigmatism generating element 140 is not oblique to the reflective beam 114 along the first direction D1, but is oblique to the reflective beam 114 along the second direction D2. In this way, when the focus of the reflective beam 114 falls between the photosensitive surface 152 and the astigmatism generating element 140 (i.e. the focus position is too near), the astigmatism generating element 140 makes the reflective beam 114 to form a beam spot S1 closed to an ellipse on the photosensitive surface 152, as that shown by a left graph of FIG. 3A. A long axis of the beam spot S1 is substantially parallel to the first direction D1, and a short axis of the beam spot S1 is substantially parallel to the second direction D2, so that relatively more light energy is projected to the second photosensitive area 154b and the fourth photosensitive area 154d, and relatively less light energy is projected to the first photosensitive area 154a and the third photosensitive area 154c. Moreover, in FIG. 2B, a convex surface of the astigmatism generating element 140a is not curved along the second direction D2, but is curved along the first direction D1. In FIG. 2C, a concave surface of the astigmatism generating element 140b is not curved along the first direction D1, but is curved along the second direction D2. In FIG. 2D, the light transparent plate 141 and the light transparent plate 143 are not oblique in the first direction D2, but are oblique with respect to the second direction D2.

In the present exemplary embodiment, a focusing method of the reflective beam 114 is to use an astigmatism method to generate a focus error signal. In the present exemplary embodiment, a focus error signal F generated by the control unit 136 after receiving the electric signal from the photo detector 150 is defined as:

F=Iₐ+I_{c}−(I_{b}+I_{d});

Wherein, Iₐ, I_{b}, I_{c} and I_{d} are respectively light energy measured at the first photosensitive area 154a, the second photosensitive area 154b, the third photosensitive area 154c and the fourth photosensitive area 154d. In case that the focus position is too near, a value of the focus error signal F is smaller than 0. The focus error signal F is correlated to the S-curve signal (for example, positive correlation). For example, by multiplying the focus error signal F with a constant, the S-curve signal is obtained.

In the present exemplary embodiment, the focusing module 130 further comprises an actuator 134, which is connected to the light converging unit 132, and is adapted to adjust a position of the light converging unit 132. Moreover, in the present exemplary embodiment, the focusing module 130 further comprises a control unit 136 electrically connected between the photo detector 150 and the actuator 134. In the present exemplary embodiment, when the control unit 136 determines that the value of the focus error signal F (or the S-curve signal) is not equal to 0, it controls the actuator 134 to adjust the position of the light converging unit 132, so that the focus position of the reflective beam 114 closes to the photosensitive surface 152.

When the focus of the reflective beam 114 just falls on the photosensitive surface 152, the astigmatism generating element 140 makes the reflective beam 114 to form a beam spot S2 closed to a circle on the photosensitive surface 152, as that shown by a middle graph of FIG. 3A. Now, a total energy of the reflective beam 114 received by the first photosensitive area 154a and the third photosensitive area 154c is substantially equal to a total energy received by the second photosensitive area 15ba and the fourth photosensitive area 154d. Now, the value of the focus error signal F is substantially equal to 0, and the control unit 136 does not control the actuator 134 to adjust the position of the light converging unit 132.

When the photosensitive surface 152 is located between the astigmatism generating element 140 and the focus of the reflective beam 114 (i.e. the focus position is too far), through the astigmatism generating element 140, a sum of energy projected to the first photosensitive area 154a and the third photosensitive area 154c by the reflective beam 114 is greater than a sum of energy projected to the second photosensitive area 154b and the fourth photosensitive area 154d by the reflective beam 114. In detail, the reflective beam 114 forms a beam spot S3 closed to an ellipse on the photosensitive surface 152, as that shown by a right graph of FIG. 3A, wherein a long axis of the beam spot S3 is substantially parallel to the second direction D2, and a short axis of the beam spot S3 is substantially parallel to the first direction D1, so that the sum of energy projected to the first photosensitive area 154a and the third photosensitive area 154c by the reflective beam 114 is greater than the sum of energy projected to the second photosensitive area 154b and the fourth photosensitive area 154d by the reflective beam 114. Now, the value of the focus error signal is greater than 0, and the control unit 136 controls the actuator 134 to adjust the position of the light converging unit 132, so that the focus position of the reflective beam 114 closes to the photosensitive surface 152.

In this way, the focusing module 130 can adjust the position of the light converging unit 132 according to the focus error signal in the electric signal transmitted by the photo detector 150. In the present exemplary embodiment, an optical path of the laser beam 112 and an optical path of the reflective beam 114 form a confocal system. In other words, when the photosensitive surface 152 falls on the focus position of the reflective beam 114, the surface 52 of the material 50 also falls on a focus position of the laser beam. Therefore, by controlling the focus of the reflective beam 114 around the photosensitive surface 152 through the focusing module 130, the focus position of the laser beam 112 is also controlled to be around the surface 52 of the material 50.

In the present exemplary embodiment, an optical path of the laser beam 122 and the optical path of the laser beam 112 also form a confocal system, so that when the focusing module 130 controls the focus position of the laser beam 112 to be around the surface 52 of the material 50, the focus position of the laser beam 122 is also controlled to be around the surface 52 of the material 50.

In the present exemplary embodiment, the material 50 does not have a reaction or an obviously reaction in response to the wavelength of the laser beam 112. However, the material 50 may have a physical, chemical or structural reaction in response to the wavelength of the laser beam 122. Therefore, when the laser beam 122 irradiates the material 50, the material 50 may have a phase variation, a physical variation, a chemical variation or a structural variation (for example, a cavity is formed). If the material 50 is photoresist, the laser beam 122 can cause an exposure reaction of the photoresist. In the present exemplary embodiment, the material 50 can be horizontally moved relative to the light converging unit 132 along a direction substantially parallel to a focal length direction of the light converging unit 132 (for example, horizontally moved along a direction D3), and the exposure system 100 comprises a control unit 160 electrically connected to the laser light source 120. When the material 50 is horizontally moved relative to the light converging unit 132 to a different position, the control unit 160 controls the laser light source 120 to or not to emit the laser beam 122, so as to determine whether or not to expose the material 50 at such position. In this way, different exposure patterns can be formed on the material 50. Moreover, based on the electric signal fed back to the focusing module 130 from the photo detector 150, the focusing module 130 can maintain the focus position of the laser beam 122 around the surface 52 of the material 50 without being influenced by other environmental factors (for example, vibration).

It should be noticed that the disclosure is not limited to the situation that the laser beam 112 and the laser beam 122 are confocal. Along with different utilization requirements and application levels, when the focus of the laser beam 112 is located around the surface 52 of the material 50, the focus of the laser beam 122 can be in a defocusing state, i.e. a distance is maintained between the focus of the laser beam 122 and the focus of the laser beam 112. In this way, a relatively great exposure beam spot can be achieved, so as to achieve different applications of the exposure system 100.

It is unnecessary to apply a photomask in the exposure system 100 of the present exemplary embodiment, so that a problem that the photomask is polluted by dust is avoided. Therefore, the exposure system 100 of the present exemplary embodiment is not limited to be used in a dust free room, which may have a wider application level. Moreover, in the exposure system 100 of the present exemplary embodiment, the electric signal (for example, the aforementioned focus error signal) is used to determine whether the reflective beam is focused at a suitable position, so as to determine whether the laser beam is focused on the surface of the material or at a suitable position therearound, and it is unnecessary to use a complicated optical system and optical device to determine whether the focusing position of the laser beam is suitable. In this way, correct exposure can be achieved under a simple structure.

Since the exposure system 100 has a simple structure, the application level of the exposure system 100 is further extended. For example, the exposure system 100 can be installed on equipments of various forms and sizes, so as to achieve various types of exposure effect. For example, the exposure system 100 can be installed on a rotating machine, so as to expose a cylindrical surface of a rotated cylindrical object. Therefore, the exposure system 100 is not limited to only expose a planar object, but can also be used to expose objects of various shapes (for example, a circular arc surface). Moreover, it should be noticed that the material 50 is not limited to be the photoresist, and in other exemplary embodiments, the material 50 can be any material required to be exposed.

In the present exemplary embodiment, the exposure system 100 further comprises a dichroic unit 170 disposed on the transmission paths of the laser beam 112, the laser beam 122 and the reflective beam 114, which is located between the laser light source 110 and the light converging unit 132, and is located between the laser light source 120 and the light converging unit 132, wherein the dichroic unit 170 combines the transmission paths of the laser beam 112 and the laser beam 122. In detail, the dichroic unit 170 is, for example, a dichroic mirror, which is adapted to reflect the laser beam 112 to the light converging unit 132, and is pervious to the laser beam 122 for transmitting the laser beam 122 to the light converging unit 132, and is adapted to reflect the reflective beam 114. However, in other exemplary embodiments, the dichroic unit 170 can also be another type of dichroic minor, which is pervious to the laser beam 112 for transmitting the laser beam 112 to the light converging unit 132, and is adapted to reflect the laser beam 122 to the light converging unit 132, and is pervious to the reflective beam 114. Moreover, in other exemplary embodiment, the dichroic unit 170 can also be a dichroic prism.

In the present exemplary embodiment, the exposure system 100 further comprises a beam splitting unit 180. The beam splitting unit 180 is adapted to transmit the laser beam 112 from the laser light source 110 to the dichroic unit 170, and transmit the reflective beam 114 from the dichroic unit 170 to the astigmatism generating element 140. Moreover, in the present exemplary embodiment, the beam splitting unit 180 is a polarizing beam splitter (PBS), and the exposure system 100 further comprises a quarter-wave plate 190. The quarter-wave plate 190 is disposed on the transmission paths of the laser beam 112 and the reflective beam 114, and is located between the beam splitting unit 180 and the dichroic unit 170. In the present exemplary embodiment, the beam splitting unit 180 is, for example, a PBS prism, though in other exemplary embodiments, the beam splitting unit 180 can also be a wire grid type PBS.

In the present exemplary embodiment, the laser beam 112 emitted from the laser light source 110 is a linear polarized light. When a linear polarization direction of the laser beam 112 does not fall in an S polarization direction of the beam splitting unit 180, and does not fall in a P polarization direction of the beam splitting unit 180, an electric field of the laser beam 112 has components in both of the S polarization direction and the P polarization direction. In the present exemplary embodiment, a part of the laser beam 112 has a first polarization direction P1, and another part of the laser beam 112 has a second polarization direction P2. The beam splitting unit 180 is pervious to the laser beam 112 having the first polarization direction P1 for transmitting it to the dichroic unit 170, and is adapted to reflect the laser beam 112 having the second polarization direction P2 so that it cannot be transmitted to the dichroic unit 170. In the present exemplary embodiment, the first polarization direction P1 is, for example, the P polarization direction of the beam splitting unit 180, and the second polarization direction P2 is, for example, the S polarization direction of the beam splitting unit 180. However, in other exemplary embodiments, the beam splitting unit 180 can also reflect the laser beam 112 having the first polarization direction P1 to the dichroic unit 170, and is pervious to the laser beam 112 having the second polarization direction P2 so that it cannot be transmitted to the dichroic unit 170. Moreover, in other exemplary embodiments, the first polarization direction P1 can be the S polarization direction of the beam splitting unit 180, and the second polarization direction P2 can be the P polarization direction of the beam splitting unit 180. In addition, in other exemplary embodiments, a disposing angle of the laser light source 110 can be adjusted, so that the linear polarization direction of the laser beam 112 is the same to the first polarization direction P1 of the beam splitting unit 180. In this way, most of the laser beam 112 can pass through the beam splitting unit 180 and is transmitted to the dichroic unit 170, so as to avoid loss of light energy.

In the present exemplary embodiment, after the laser beam 112 having the first polarization direction P1 (i.e. the P polarization direction) passes through the quarter-wave plate 190, a polarization state of the laser beam 112 is converted into a circular polarization state. After the laser beam 112 having the circular polarization state is reflected by the material 50 to form the reflective beam 114, the reflective beam 114 also has the circular polarization state. In the present exemplary embodiment, the dichroic unit 170 reflects the reflective beam 114 to the quarter-wave plate 190. The quarter-wave plate 190 coverts the polarization state of the reflective beam 114 from the circular polarization state to linear polarization state, and a direction of the linear polarization state is the second polarization direction P2 (i.e. the S polarization direction) of the beam splitting unit 180. The beam splitting unit 180 transmits the reflective beam 114 having the second polarization direction P2 to the photo detector 150. In the present exemplary embodiment, the beam splitting unit 180 reflects the reflective beam 114 having the second polarization direction P2 to the photo detector 150. However, in other exemplary embodiment, the beam splitting unit 180 can also be pervious to the reflective beam 114 having the second polarization direction P2 for transmitting it to the photo detector 150.

It should be noticed that in the disclosure, the beam splitting unit 180 is not limited to be the PBS, and in other exemplary embodiments, a partial-pervious and partial-reflective device can be used to replace the beam splitting unit 180 of the present exemplary embodiment, and the quarter-wave plate 190 is not used.

In the present exemplary embodiment, the exposure system 100 further comprises a light converging unit 210, which is disposed on the transmission path of the reflective beam 114, and is located between the beam splitting unit 180 and the photo detector 150. Moreover, in the present exemplary embodiment, the exposure system 100 further comprises a lens 220, which is disposed on the transmission path of the reflective beam 114, and is located between the dichroic unit 170 and the beam splitting unit 180, wherein the lens 220 has a function of quasi-collimating the laser beam 112 (the lens 220 is also referred to as a quasi-collimator). However, in other exemplary embodiments, the lens 220 can also be disposed between the beam splitting unit 180 and the laser light source 110, and is located on the transmission path of the laser beam 112.

In the present exemplary embodiment, the exposure system 100 further comprises a beam splitting unit 230 and a power detector 240. The beam splitting unit 230 is adapted to transmit a part of the laser beam 122 from the laser source 120 to the dichroic unit 170. The power detector 240 is electrically connected to the laser light source 120. In the present exemplary embodiment, the beam splitting unit 230 is adapted to transmit another part of the laser beam 122 from the laser light source 120 to the power detector 240. However, in other exemplary embodiments, the another part of the laser beam 122 can also be transmitted to the power detector 240 without using the beam splitting unit 230, and another beam splitting unit can be disposed at any place on the optical path of the laser beam 122 between the laser light source 120 and the material 50, so as to split a part of the laser beam 122 to the power detector 240. In the present exemplary embodiment, the beam splitting unit 230 is, for example, a PBS, a part of the laser beam 122 has the first polarization direction P1 (for example, a P polarization direction of the beam splitting unit 230), and another part of the laser beam 122 has the second polarization direction P2 (for example, an S polarization direction of the beam splitting unit 230). The beam splitting unit 230 is pervious to the laser beam 122 having the first polarization direction P1 for transmitting it to the dichroic unit 170, and reflects the laser beam 122 having the second polarization direction P2 to the power detector 240. However, in other exemplary embodiments, the beam splitting unit can also reflect the laser beam 122 having the first polarization direction to the dichroic unit 170, and is pervious to the laser beam 122 having the second polarization direction P2 for transmitting it to the power detector 240.

The control unit 160 is electrically connected between the power detector 240 and the laser light source 120, wherein the control unit 160 adjusts an output power of the laser light source 120 acceding to a power of the another part of the laser beam 122 (i.e. the laser beam 122 having the second polarization direction P2) detected by the power detector 240, so as to control the exposure state under an expected condition.

In the present exemplary embodiment, the exposure system 100 further comprises a lens 250, which is disposed on the transmission path of the laser beam 122, and is located between the laser light source 120 and the beam splitting unit 230 for collimating the laser beam 122.

In the present exemplary embodiment, the exposure system 100 further comprises an astigmatism generating element 260 and a photo detector 270. The astigmatism generating element 260 is the same or similar to the astigmatism generating element 140a, 140b, 140c or 140d of FIGS. 2A-2D, and the photo detector 270 is the same or similar to the photo detector 150 of FIGS. 2A-2D, and a configuration relation of the astigmatism generating element 260 and the photo detector 270 can be as that shown in FIGS. 2A-2D, which is not repeated herein.

When the material 50 reflects a part of the laser beam 122 into a reflective beam 124, the reflective beam 124 is transmitted to the dichroic unit 170 through the light converging unit 132. The dichroic unit 170 transmits the reflective beam 124 to the beam splitting unit 230, and the beam splitting unit 230 transmits the reflective beam 124 to the astigmatism generating element 260. The photo detector 270 is disposed on a transmission path of the reflective beam 124 from the astigmatism generating element 260.

In the present exemplary embodiment, the exposure system 100 further comprises a quarter-wave plate 280, which is disposed on the transmission paths of the laser beam 122 and the reflective beam 124, and is located between the beam splitting unit 230 and the dichroic unit 170. In the present exemplary embodiment, after the laser beam 122 having the first polarization direction P1 passes through the quarter-wave plate 280, a polarization state thereof is converted into the circular polarization state, so that the reflective beam 124 reflected by the material 50 also has the circular polarization state. After the reflective beam 124 passes through the quarter-wave plate 280, a polarization state thereof is converted from the circular polarization state to the linear polarization state, and a direction of the linear polarization state is the second polarization direction P2. Therefore, the beam splitting unit 230 can reflect the reflective beam 124 having the second polarization direction P2 to the astigmatism generating element 260.

Moreover, in other exemplary embodiments, the beam splitting unit 230 can also be a partial-pervious and partial-reflective device, and the quarter-wave plate 190 is not used. In the present exemplary embodiment, the exposure system 100 further comprises a light converging unit 290, which is disposed on the transmission path of the reflective beam 124, and is located between the beam splitting unit 230 and the photo detector 270.

In the present exemplary embodiment, the laser light source 110, the beam splitting unit 180, the light converging unit 210, the astigmatism generating element 140, the photo detector 150, the quarter-wave plate 190 and the lens 220 may form a servo optical module 400, which is used for adjusting the position of the light converging unit 132, so that the laser beam 122 may have a better focusing effect and exposure effect. Moreover, in the present exemplary embodiment, the laser light source 120, the control unit 160, the power detector 240, the lens 250, the beam splitting unit 230, the quarter-wave plate 280, the light converging unit 290, the astigmatism generating element 260 and the photo detector 270 may form an exposure optical module 500, which is used for exposing the material 50.

The photo detector 270, the astigmatism generating element 260 and the light converging unit 290 are used to adjust the laser beam 122 and the laser beam 112 to be confocal (i.e. focuses of the laser beams 122 and 112 passing through the light converging unit 132 are overlapped) when the exposure system 100 is assembled, or maintain a suitable distance between the focus of the laser beam 122 and the laser beam 112. Therefore, after the exposure system 100 is assembled, the photo detector 270, the astigmatism generating element 260 and the light converging unit 290 can be detached from the exposure system 100, or can also be maintained within the exposure system 100. Therefore, in other exemplary embodiments, the exposure system 100 may not comprise the photo detector 270, the astigmatism generating element 260 and the light converging unit 290.

A method of adjusting the laser beam 122 and the laser beam 112 to be confocal, or maintaining a suitable distance between the focuses of the laser beam 122 and the laser beam 112 when the exposure system 100 is assembled is introduced below.

FIG. 4A is a flowchart illustrating an adjustment method of an exposure system according to an exemplary embodiment of the disclosure, and FIG. 4B is a schematic diagram illustrating a specimen mentioned in FIG. 4A. Referring to FIG. 1, FIG. 4A and FIG. 4B, the adjustment method of the exposure system of the present exemplary embodiment can be used to adjust the exposure system 100 of FIG. 1, and the adjustment method of the exposure system comprises following steps. First, a step S108 is executed, by which a beam spot checker is used to confirm whether positions and sizes of a beam spot 112A formed after the laser beam 112 emitted from the laser light source 110 being transmitted to the light converging unit 132 and a beam spot 122A formed after the laser beam 122 emitted from the laser light source 120 being transmitted to the light converging unit 132 meet a demand. Such step can make a preliminary confirmation in optics, wherein a size of the beam spot is correlated to a wavelength of the laser beam, which can be calculated, theoretically. Next, a step S110 is executed, by which a specimen 50′ shown in FIG. 4B is provided. In the present exemplary embodiment, a disposing position of the specimen 50′ is the same to the disposing position of the material 50. Resemblance of the specimen 50′ and the material 50 is that the specimen 50′ also reflects at least a part of the laser beam 122 into the reflective beam 124, and reflects at least a part of the laser beam 112 into the reflective beam 114. Therefore, when the material 50 is replaced by the specimen 50′, the optical paths in the exposure system 100 are not changed. In the present exemplary embodiment, the specimen 50′ has a plurality of small regions 54′, and the small regions 54′ are, for example, depressed or protruded small regions.

Next, a step S120 is executed, by which the laser light source 120 emits the laser beam 122, which is transmitted to the specimen 50′ through the light converging unit 132, wherein the specimen 50′ is adapted to reflect the laser beam 122 into the reflective beam 124. Moreover, the reflective beam 124 is transmitted to the photo detector 270 through the light converging unit 132 and the astigmatism generating element 260.

Next, a step S130 is executed, by which a state of the photo detector 270 is adjusted to change a quality of a first electric signal generated by a control unit 137 electrically connected to the photo detector 270 when the reflective beam 124 is focused on the photo detector 270, and if the quality of the first electric signal is within a first tolerance range, the control unit 137 is locked. In detail, the control unit 137 and the control unit 136 are substantially the same, and the control unit 137 is also electrically connected to the actuator 134, and can also generate an S-curve signal or an electric signal (which can be the RF signal). In the present exemplary embodiment, if the quality of the S-curve signal is within the first tolerance range, the control unit 137 is locked. Here, locking of the control unit 137 is defined as that the control unit 137 no longer controls the actuator 134 to drive the light converging unit 132 to perform scanning-type operations back and forth, but controls the actuator 134 to drive the light converging unit 132 to slightly move up and down along the surface of the material 50, so as to maintain the focusing state of the laser beam 122 to an expected state (for example, a good state). In the present exemplary embodiment, the state of the photo detector 270 can be the position of the photo detector 270 or the focusing state of the reflective beam 124 on the photo detector 270 (for example, the focusing state of the reflective beam 124 on the photo detector 270 is varied by changing positions of the light converging unit 290 and the astigmatism generating element 260). In the present exemplary embodiment, when the quality of the S curve signal is within the first tolerance range, it means that the S-curve has a good symmetry, and a voltage range matches an expectation. In the present exemplary embodiment, after the control unit 137 is locked, the control unit 137 processes the electric signal transmitted by the photo detector 270, and in the present exemplary embodiment, the electric signal is processed into a reading signal (RF signal), which is, for example, a high-frequency signal shown in FIG. 4C, and the control unit 137 determines whether the high-frequency signal has a good quality. The good quality of the high-frequency signal refers to that the voltage of the high-frequency signal is adjusted to a maximum value, and the signal has a state (for example, a clear signal) similar as that shown in FIG. 4C.

Next, a step S140 is executed, by which the laser light source 110 emits the laser beam 112, which is transmitted to the specimen 50′ through the light converging unit 132. The specimen 50′ is adapted to reflect the laser beam 112 into the reflective beam 114, and the reflective beam 114 is transmitted to the photo detector 150 through the light converging unit 132 and the astigmatism generating element 140.

Next, a step S150 is executed, by which a state of the photo detector 150 is adjusted to change a quality of a second electric signal generated by the control unit 136 after the photo detector 150 receives the reflective beam 114. If the quality of the second electric signal is within a second tolerance range, for example, the electric signal (which is a high-frequency signal in the present exemplary embodiment) generated by the control unit 136 has a good quality as that shown in FIG. 4C, the adjustment is completed, or a step S160 is executed, if the electric signal has a poor quality, the step S108 is repeated.

Next, in this embodiment, the step S160 is continually executed. In the present exemplary embodiment, the laser light sources 120 and 110 are first turned off, and then the laser light source 110 is turned on to emit the laser beam 112. Then, the control unit 136 is locked, and definition of locking the control unit 136 is the same to that of locking the aforementioned control unit 137. Then, the laser light source 120 emits the laser beam 122, and it is determined whether the electric signal of the photo detector 270 is the same as that described in the step S130 (i.e. the high-frequency signal shown in FIG. 4C), if yes, it represents that the electric signal meets the demand, and the adjustment is completed, and if not, the step S150 is repeated for readjustment.

Now, the adjustment of the exposure system 100 is completed. It should be noticed that according to the adjustment method of the present exemplary embodiment, the focus of the laser beam 122 can be controlled to fall on the specimen 50′ or not to fall on the specimen 50′, which is determined according to an actual utilization requirement and utilization level. When the focus of the laser beam 122 does not fall on the specimen 50′, a distance is maintained between the focuses of the laser beam 122 and the laser beam 112.

In other exemplary embodiments, an executing sequence of the laser light source 120 and the laser light source 110 can be exchanged, and an executing sequence of the photo detector 270 and the photo detector 150 is also exchanged. In other words, in the step S120, the laser light source 110 emits the laser beam 112, and in the step S130, the quality of the electric signal generated by the reflective beam 114 is adjusted, and the control unit 136 of the photo detector 150 is locked when the electric signal is within the second tolerance range. Moreover, in the step S140, the laser light source 120 emits the laser beam 122, and in the step S150, the quality of the electric signal of the photo detector 270 is confirmed, and in the step S160, the quality of the electric signal of the photo detector 150 is confirmed.

Moreover, in other exemplary embodiments, the step S140 can also be executed between the step S120 and the step S130, or can be executed before the step S120, or the step S140 and the step S120 can be simultaneously executed.

According to the adjustment method of the exposure system of the present exemplary embodiment, the states of the two photo detectors 270 and 150 are adjusted in succession, and it is observed whether the qualities of the electric signals are enough to complete focusing the laser beam 122 and 112. Therefore, a good focusing effect can be achieved through simple steps, and the exposure system 100 having high exposure correctness and wide application level is obtained through the adjustment.

It should be noticed that the control unit 137 can be removed after the adjustment is completed, which may be not maintained in the exposure system 100.

A detailed structure of the actuator 134 is introduced below.

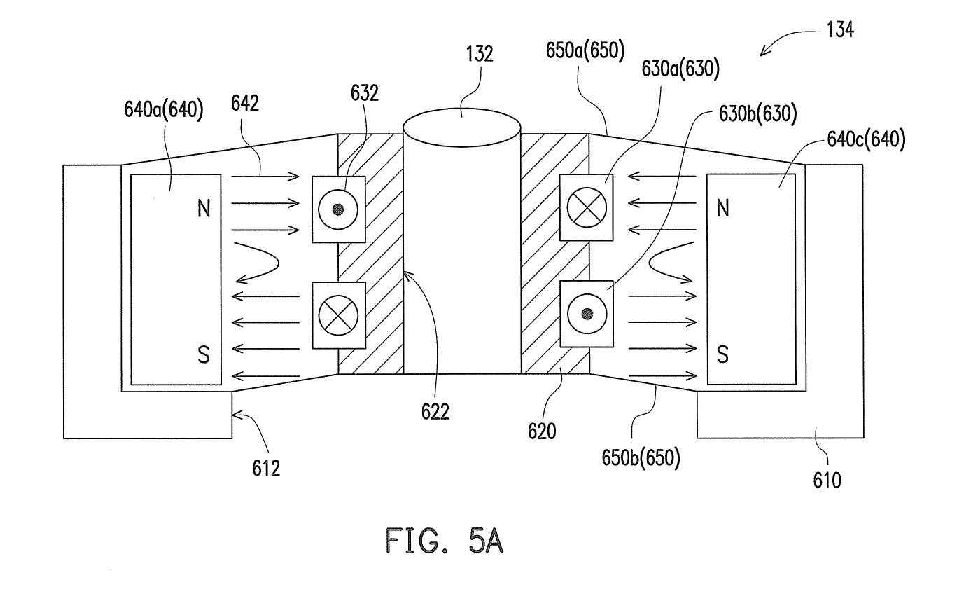

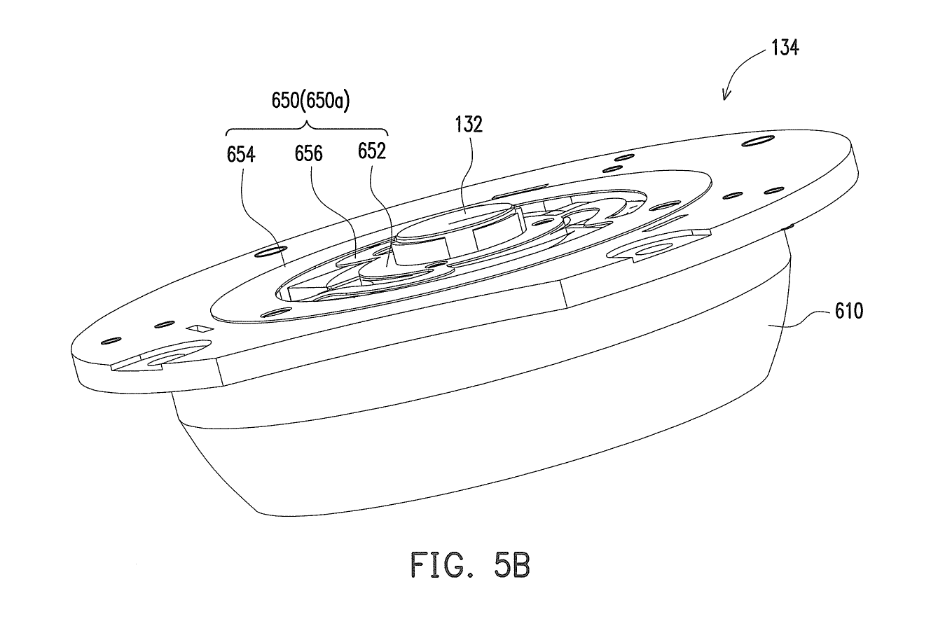

FIG. 5A is a cross-sectional view of the actuator and the light converging unit of FIG. 1, and FIG. 5B is a three-dimensional view of the actuator and the light converging unit of FIG. 1. Referring to FIG. 1, FIG. 5A and FIG. 5B, in the present exemplary embodiment, the actuator 134 comprises a base 610, a light converging unit holder 620 (e.g. a lens holder), at least one coil 630 (in FIG. 5A, two coils 630a and 630b are taken as an example), at least one magnetic element 640 (in FIG. 5A, two magnetic elements 640a and 640c are taken as an example), and at least one suspension device (in FIG. 5A, two suspension devices are taken as an example). In the present exemplary embodiment, the suspension devices are spring pieces 650 (in FIG. 5A, two spring pieces 650a and 650b are taken as an example). The light converging unit holder 620 carries the light converging unit 132, and is disposed in the base 610. The coil 630 winds the light converging unit holder 620. The magnetic element 640 is disposed in the base 610 for providing a magnetic filed 642 to the coil 630. In the cross-sectional view of FIG. 5A, a direction of the magnetic field 642 is substantially perpendicular to an extending direction of the coil 630. By applying current 632 with different magnitudes and different directions to the coil 630, a position of the light converging unit holder 620 is changed, so that a position of the light converging unit 132 is accordingly changed. The spring piece 650 is connected to the base 610 and the light converging unit holder 620. In the present exemplary embodiment (FIG. 5B), the spring piece 650 comprises an inner ring 652, an outer ring 654 and a plurality of connecting parts 656. The inner ring 652 is fixed on the light converging unit holder 620, the outer ring 654 is fixed on the base 610, and each of the connecting parts 656 is connected to the inner ring 652 and the outer ring 654. In the present exemplary embodiment, the spring piece 650a is fixed at the top of the base 610 and the top of the light converging unit holder 620, and the spring piece 650b is fixed at the bottom of the base 610 and the bottom of the light converging unit holder 620.

Moreover, in the present exemplary embodiment, the light converging unit holder 620 has an opening 622, and the base 610 has an opening 612. The laser beams 122 and 112 and the reflective beams 124 and 114 can pass through the openings 622 and 612, and pass through the light converging unit 132.

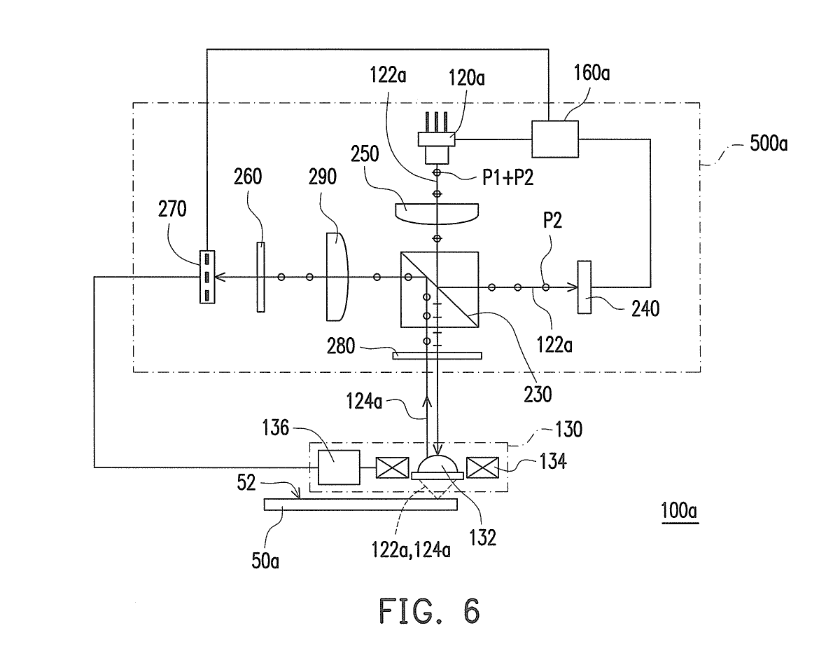

FIG. 6 is a structural schematic diagram illustrating an exposure system according to another exemplary embodiment of the disclosure. Referring to FIG. 6, the exposure system 100a of the present exemplary embodiment is partially similar to the exposure system 100 of FIG. 1, wherein like reference numerals in FIG. 6 and FIG. 1 denote like elements, and differences between the exposure system 100a of the present exemplary embodiment and the exposure system 100 of FIG. 1 are as follows. In the exposure system 100a of the present exemplary embodiment, the whole servo optical module 400 and the dichroic unit 170 of FIG. 1 are omitted, and in case of a low power (for example, lower than a threshold or a threshold range) of the laser beam 122a emitted by the laser light source 120a, the material 50a does not have the reaction as that described in the exemplary embodiment of FIG. 1, and in case of a high power (for example, higher than the threshold or the threshold range) of the laser beam 122a, the material 50a may have the exposure reaction as that described in the exemplary embodiment of FIG. 1. Therein, the optical path of the laser beam 122a does not comprise the dichroic unit 170 of FIG. 1, and the other optical paths are the same to the optical paths of the laser beam 122 of FIG. 1, so that detailed descriptions thereof are not repeated. Moreover, the optical path of the reflective beam 124a generated by the material 50a after reflecting the laser beam 122a does not comprise the dichroic unit 170 of FIG. 1, and the other optical paths are the same to the optical paths of the reflective beam 124 of FIG. 1, so that detailed descriptions thereof are not repeated.

Moreover, in the present exemplary embodiment, the focusing module 130 is electrically connected to the photo detector 270 (for example, the control unit 136 of the focusing module 130 is electrically connected to the photo detector 270). The photo detector 270 receives the reflective beam 124a to generate the electric signal, and transmits the electric signal to the control unit 136, and the control unit 136 accordingly generate a focus error signal (the focus error signal in the exemplary embodiment of FIG. 1). Therefore, the focusing module 130 can adjust a suitable position of the light converging unit 132 according to the focus error signal, so as to focus the laser beam 122a on the surface 52 of the material 50a, or maintain a distance between the focuses of the laser beam 122a and the surface 52. For example, the material 50a is an inorganic photoresist, which does not have the exposure reaction in case of the low power laser beam, and have the exposure reaction in case of the high power laser beam, and the material 50 of FIG. 1 is, for example, an organic photoresist.

In the present exemplary embodiment, the control unit 160a is adapted to be switched to an exposure mode and a servo mode. An output power of the laser light source 120a corresponding to the exposure mode of the control unit 160a is greater than the output power of the laser light source 120a corresponding to the servo mode of the control unit 160a. When the control unit 160a is switched to the exposure mode, the laser beam 122a causes a variation of the material 50a. Moreover, when the control unit 160a is switched to the servo mode, the photo detector 270 detects the reflective beam 124a, and generates the electric signal according to a detecting result.

In detail, the control unit 160a controls the laser light source 120a to continually emit the laser beam 122a, and when the material 50a is moved relative to the light converging unit 132 to a position to be exposed, the control unit 160a controls the laser light source 120a to increase the power of the laser beam 122a. When the material 50a is moved relative to the light converging unit 132 to a position not to be exposed, the control unit 160a controls the laser light source 120a to maintain a relative low power of the laser beam 122a, and now the photo detector 270 continually transmits the focus error signals to the focusing module 130 to maintain the light converging unit 130 at a suitable position. Moreover, in the present exemplary embodiment, the control unit 160a can also be electrically connected to the photo detector 270, and when the power detector 240 detects that the power of the laser beam 122a is increased to a relatively high level (which is enough to cause the exposure reaction), the control unit 160a turns off the photo detector 270, so as to avoid the control unit 160a receiving excessive reflective beam 124a. In this way, in the present exemplary embodiment, the laser light source 120a, the control unit 160a, the power detector 240, the lens 250, the beam splitting unit 230, the quarter-wave plate 280, the light converging unit 290, the astigmatism generating element 260 and the photo detector 270 can be regarded as an exposure-servo optical module 500a simultaneously having the exposure function and the servo function.

Moreover, none grating is disposed on the transmission path of the laser beam 122a between the laser light source 120a and the material 50a, and setting of the grating is unnecessary, so that the exposure system 100a has a relatively simple optical structure.

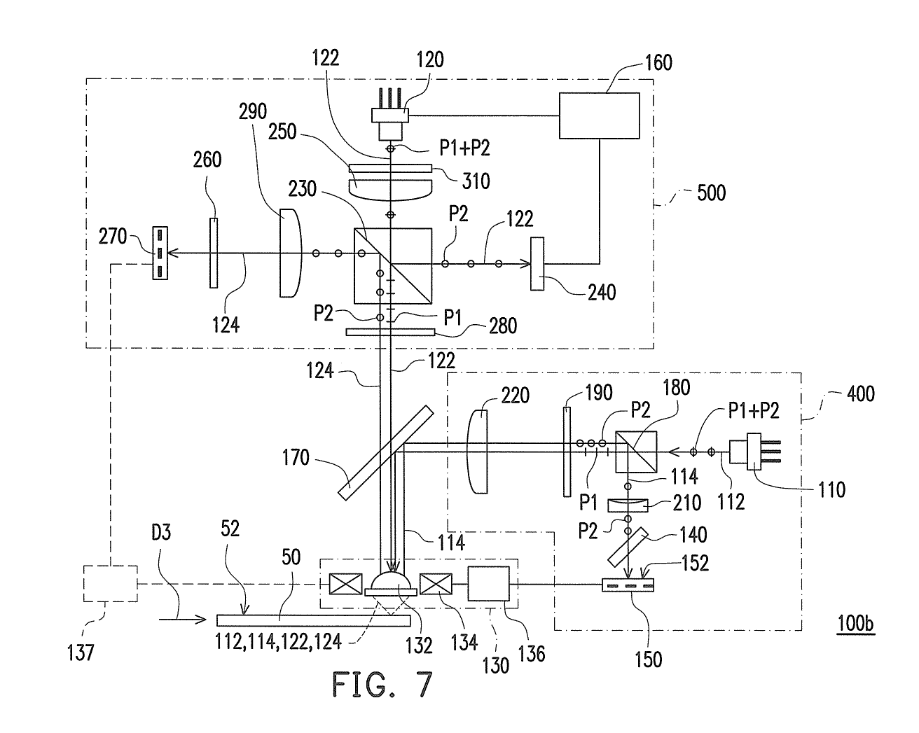

FIG. 7 is a structural schematic diagram illustrating an exposure system according to still another exemplary embodiment of the disclosure. Referring to FIG. 7, the exposure system 100b of the present exemplary embodiment is similar to the exposure system 100 of FIG. 1, and a difference therebetween is that in the exposure system 100b of the present exemplary embodiment, a grating 310 is disposed on the transmission path of the laser beam 122 between the laser light source 120 and the material 50. The grating 310 can diffract the laser beam 122 into a plurality of sub beams, and the sub beams can simultaneously irradiate different regions on the material 50. In this way, an exposure efficiency is increased, and an exposure time of the material 50 is shortened.

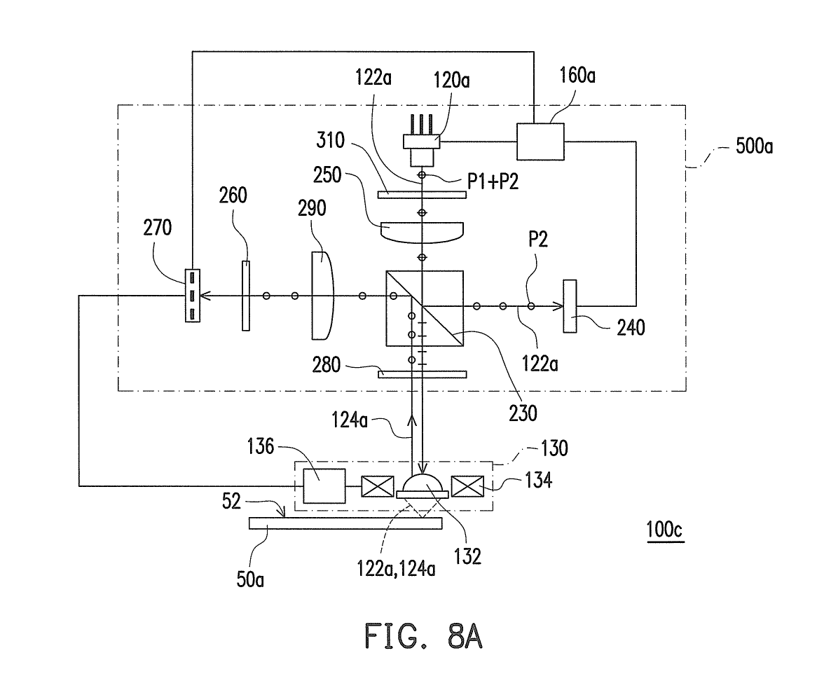

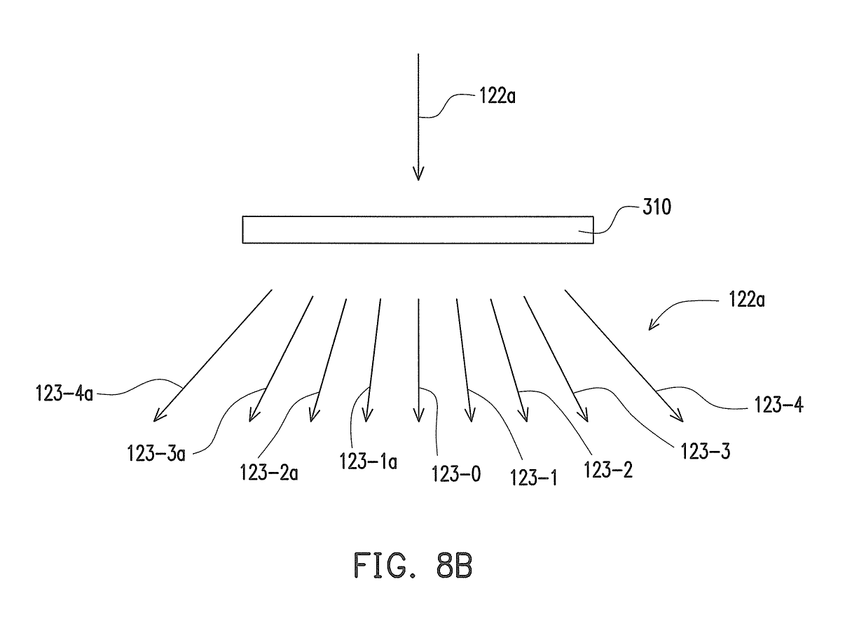

FIG. 8A is a structural schematic diagram illustrating an exposure system according to yet another exemplary embodiment of the disclosure, and FIG. 8B illustrates multiorder diffraction beams generated by a grating. Referring to FIG. 8A and FIG. 8B, the exposure system 100c of the present exemplary embodiment is similar to the exposure system 100a of FIG. 6, and a difference therebetween is that in the exposure system 100c of the present exemplary embodiment, a grating 310 is disposed on the transmission path of the laser beam 122a between the laser light source 120a and the material 50a. In the present exemplary embodiment, the grating 310 diffracts the laser beam 122a into multiorder diffraction beams, and in FIG. 8B, diffraction beams 123-0˜123-4 and diffraction beams 123-1a˜123-4a are illustrated, though the disclosure is not limited thereto. In the present exemplary embodiment, the diffraction beam 123-0 is a 0-order diffraction beam, the diffraction beam 123-1 is a 1-order diffraction beam, and the diffraction beam 123-1a is a −1-order diffraction beam, wherein absolute values of order numbers of the diffraction beams 123-1 and 123-1a are all 1. The diffraction beam 123-2 is a 2-order diffraction beam, and the diffraction beam 123-2a is a −2-order diffraction beam, wherein absolute values of order numbers of the diffraction beams 123-2 and 123-2a are all 2. The diffraction beam 123-3 is a 3-order diffraction beam, and the diffraction beam 123-3a is a −3-order diffraction beam, wherein absolute values of order numbers of the diffraction beams 123-3 and 123-3a are all 3. The diffraction beam 123-4 is a 4-order diffraction beam, and the diffraction beam 123-4a is a −4-order diffraction beam, wherein absolute values of order numbers of the diffraction beams 123-4 and 123-4a are all 4. Other diffraction beams with the absolute values of the order numbers greater than 5 are not illustrated. In the present exemplary embodiment, in the multiorder diffraction beams, at least the diffraction beams having the absolute values of the order numbers bing 0, 1, 2 and 3 (for example, the diffraction beams 123-0, 123-1, 123-1a, 123-2, 123-2a, 123-3 and 123-3a) may cause the exposure reaction of the material. For example, light intensities of the diffraction beams 123-0, 123-1, 123-1a, 123-2, 123-2a, 123-3 and 123-3a are enough to cause the exposure reaction of the material, and are only used for the function of material exposure. In other exemplary embodiments, the diffraction beams having the absolute values of the order numbers from 0-N may cause the exposure reaction of the material, wherein N is an integer such as 4, 5, 6, 7, 8, 9, 10, or greater integers, though the disclosure is not limited thereto.

The diffraction beams can simultaneously irradiate different regions on the material 50a. In this way, the exposure efficiency is increased, and the exposure time of the material 50a is shortened.

In summary, in the exposure system according to the embodiment of the disclosure, an astigmatism generating element and a photo detector are used to generate an electric signal, and whether a reflective beam is focused at a suitable position is determined according to the electric signal, so as to determine whether a laser beam is focused on the surface of the material or focused at a suitable position therearound. In this way, correct exposure can be achieved under a simple structure. Moreover, since the exposure system of the disclosure does not apply a photomask, it may have a relatively wide application level, and have less demanding on the utilization environment. Moreover, according to the adjustment method of the exposure system of the disclosure, qualities of two focusing beam spots are first confirmed to meet the demand, and after a photo detector is adjusted to a required state, a servo of a control unit is locked, and then it is observed whether a quality of another high-frequency electric signal is enough to complete focusing the two laser beams. Namely, a requirement of two focuses in optics is first achieved, and then two photo detectors are used to confirm that a servo-electric control also achieve a requirement of adjusting the two focuses. In this way, a good focusing effect can be achieved through simple steps, so as to obtain the exposure system with high exposure correctness and wide application level through adjustment. Moreover, since a grating may be unnecessary to be disposed on the transmission path of the laser beam between the laser light source and the material, the exposure system of the disclosure may have relatively simple optical structure.

In addition, the exposure system according to the embodiment of the disclosure may use a grating to diffract the laser beam into multiorder diffraction beams, and in the multiorder diffraction beams, at least the diffraction beams having absolute values of order numbers being 0, 1, 2 and 3 may cause the exposure reaction of the material. In this way, the exposure efficiency is increased, and the exposure time of the material is shortened.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An exposure system, adapted to expose a material, the exposure system comprising:
a first laser light source, adapted to emit a first laser beam;
a second laser light source, adapted to emit a second laser beam, wherein a wavelength of the second laser beam is different to that of the first laser beam;
a focusing module, comprising a first light converging unit, wherein the first light converting unit is disposed on transmission paths of the first laser beam and the second laser beam for projecting the first laser beam and the second laser beam onto the material, the material is adapted to reflect at least a part of the first laser beam into a first reflective beam, and the first light converging unit is disposed on a transmission path of the first reflective beam;
a first astigmatism generating element, disposed on a transmission path of the first reflective beam from the first light converging unit; and
a first photo detector, disposed on a transmission path of the first reflective beam from the first astigmatism generating element, and electrically connected to the focusing module, wherein the first photo detector is adapted to detect the first reflective beam, and generate an electric signal according to a detecting result, and the focusing module adjusts a distance between the first light converging unit and the material according to the electric signal.

2. The exposure system as claimed in claim 1, wherein the first photo detector comprises a photosensitive surface, and the photosensitive surface comprises a first photosensitive area, a second photosensitive area, a third photosensitive area and a fourth photosensitive area, wherein the first photosensitive area is located opposite to the third photosensitive area, and the second photosensitive area is located opposite to the fourth photosensitive area, the first photosensitive area is located adjacent to the second photosensitive area and the fourth photosensitive area, and the third photosensitive area is located adjacent to the second photosensitive area and the fourth photosensitive area.

3. The exposure system as claimed in claim 1, wherein the first astigmatism generating element comprises a cylinder lens or a light transparent plate oblique to the first reflective beam.

4. The exposure system as claimed in claim 1, further comprising a dichroic unit, disposed on the transmission paths of the first laser beam, the second laser beam and the first reflective beam, and located between the first laser light source and the first light converging unit, and located between the second laser light source and the first light converging unit, wherein the dichroic unit combines the transmission paths of the first laser beam and the second laser beam.

5. The exposure system as claimed in claim 4, further comprising a first beam splitting unit, adapted to transmit the first laser beam from the first laser light source to the dichroic unit, and transmit the first reflective beam from the dichroic unit to the first astigmatism generating element.

6. The exposure system as claimed in claim 5, wherein the first beam splitting unit is a polarizing beam splitter (PBS), and the exposure system further comprises:
a quarter-wave plate, disposed on the transmission paths of the first laser beam and the first reflective beam, and located between the first beam splitting unit and the dichroic unit; and
a second light converging unit, disposed on the transmission path of the first reflective beam, and located between the first beam splitting unit and the first photo detector.

7. The exposure system as claimed in claim 4, further comprising:
a second beam splitting unit, disposed on the transmission path of the second laser beam, and located between the second laser light source and the material, wherein a part of the second laser beam from the second beam splitting unit is transmitted to the material;
a power detector, electrically connected to the second laser light source, and disposed on a transmission path of another part of the second laser beam from the second beam splitting unit; and
a control unit, electrically connected between the power detector and the second laser light source, wherein the control unit adjusts an output power of the second laser light source according to a power of the another part of the second laser beam detected by the power detector.

8. The exposure system as claimed in claim 4, further comprising:
a second beam splitting unit, adapted to transmit a part of the second laser beam from the second laser light source to the dichroic unit;
a second astigmatism generating element, wherein when the material reflects a part of the second laser beam into a second reflective beam, the second reflective beam is transmitted to the dichroic unit through the first light converging unit, and the dichroic unit is adapted to transmit the second reflective beam to the second beam splitting unit, and the second beam splitting unit is adapted to transmit the second reflective beam to the second astigmatism generating element; and
a second photo detector, disposed on a transmission path of the second reflective beam from the second astigmatism generating element.

9. The exposure system as claimed in claim 8, wherein the second beam splitting unit is a polarizing beam splitter, and the exposure system further comprises:
a quarter-wave plate, disposed on the transmission paths of the second laser beam and the second reflective beam, and located between the second beam splitting unit and the dichroic unit; and
a third light converging unit, disposed on the transmission path of the second reflective beam, and located between the second beam splitting unit and the second photo detector.

10. The exposure system as claimed in claim 1, wherein the focusing module further comprises an actuator connected to the first light converging unit and adapted to adjust a position of the first light converging unit, wherein the actuator comprises:
a base;
a light converging unit holder, carrying the first light converging unit, and disposed in the base;
a coil, winding the light converging unit holder;
at least a magnetic element, disposed in the base, and adapted to provide a magnetic field to the coil; and
at least a suspension device, connected to the base and the light converging unit holder.

11. The exposure system as claimed in claim 1, further comprising a grating disposed on the transmission path of the second laser beam and located between the second laser light source and the material.

12. An exposure system, adapted to expose a material, the exposure system comprising:
a laser light source, adapted to emit a laser beam;
a focusing module, comprising a first light converging unit, wherein the first light converging unit is disposed on a transmission path of the laser beam for projecting the laser beam onto the material, the material is adapted to reflect at least a part of the laser beam into a reflective beam, and the first light converging unit is disposed on a transmission path of the reflective beam, and none grating is disposed on the transmission path of the laser beam between the laser light source and the material;
an astigmatism generating element, disposed on a transmission path of the reflective beam from the first light converging unit; and
a photo detector, disposed on a transmission path of the reflective beam from the astigmatism generating element, and electrically connected to the focusing module, wherein the photo detector is adapted to detect the reflective beam, and generate an electric signal according to a detecting result, and the focusing module adjusts a distance between the first light converging unit and the material according to the electric signal.

13. The exposure system as claimed in claim 12, wherein the photo detector comprises a photosensitive surface, and the photosensitive surface comprises a first photosensitive area, a second photosensitive area, a third photosensitive area and a fourth photosensitive area, wherein the first photosensitive area is located opposite to the third photosensitive area, and the second photosensitive area is located opposite to the fourth photosensitive area, the first photosensitive area is located adjacent to the second photosensitive area and the fourth photosensitive area, and the third photosensitive area is located adjacent to the second photosensitive area and the fourth photosensitive area.

14. The exposure system as claimed in claim 12, wherein the astigmatism generating element comprises a cylinder lens or a light transparent plate oblique to the reflective beam.

15. The exposure system as claimed in claim 12, further comprising a beam splitting unit, adapted to transmit the laser beam from the laser light source to the first light converging unit, and transmit the reflective beam from the first light converging unit to the astigmatism generating element.

16. The exposure system as claimed in claim 15, wherein the beam splitting unit is a polarizing beam splitter, and the exposure system further comprises:
a quarter-wave plate, disposed on the transmission paths of the laser beam and the reflective beam, and located between the beam splitting unit and the first light converging unit; and
a second light converging unit, disposed on the transmission path of the reflective beam, and located between the beam splitting unit and the photo detector.

17. The exposure system as claimed in claim 12, further comprising:
a beam splitting unit, adapted to transmit a part of the laser beam from the laser light source to the first light converging unit;
a power detector, electrically connected to the laser light source, wherein the beam splitting unit is adapted to transmit another part of the laser beam from the laser light source to the power detector; and
a control unit, electrically connected between the power detector and the laser light source, wherein the control unit adjusts an output power of the laser light source according to a power of the another part of the laser beam detected by the power detector.

18. The exposure system as claimed in claim 12, further comprising a control unit, electrically connected to the laser light source, wherein the control unit is adapted to be switched to an exposure mode and a servo mode, an output power of the laser light source corresponding to the exposure mode of the control unit is greater than the output power of the laser light source corresponding to the servo mode of the control unit, and when the control unit is switched to the exposure mode, the laser beam causes a variation of the material, and when the control unit is switched to the servo mode, the photo detector detects the reflective beam, and generates the electric signal according to a detecting result.

19. The exposure system as claimed in claim 12, wherein the focusing module further comprises an actuator connected to the first light converging unit and adapted to adjust a position of the first light converging unit, wherein the actuator comprises:
a base;
a light converging unit holder, carrying the first light converging unit, and disposed in the base;
a coil, winding the light converging unit holder;
at least a magnetic element, disposed in the base, and adapted to provide a magnetic field to the coil; and
at least a suspension device, connected to the base and the light converging unit holder.

20. An adjustment method of an exposure system, comprising:
providing a specimen;
emitting a first laser beam by a first laser light source of the exposure system, which is transmitted to the specimen through a light converging unit of the exposure system, wherein the specimen is adapted to reflect at least a part of the first laser beam into a first reflective beam, and the first reflective beam is transmitted to a first photo detector of the exposure system through the light converging unit and a first astigmatism generating element of the exposure system;
adjusting a quality of a first electric signal formed on the first photo detector by the first reflective beam by adjusting a state of the first photo detector, wherein when the quality of the first electric signal is within a first tolerance range, a first control unit electrically connected to the first photo detector is locked;
emitting a second laser beam by a second laser light source of the exposure system, which is transmitted to the specimen through the light converging unit of the exposure system, wherein a wavelength of the second laser beam is different to that of the first laser beam, the specimen is adapted to reflect the second laser beam into a second reflective beam, and the second reflective beam is transmitted to a second photo detector of the exposure system through the light converging unit and a second astigmatism generating element of the exposure system; and
adjusting a second electric signal generated by the second photo detector after receiving the second reflective beam by adjusting a state of the second photo detector, and confirming whether the second electric signal is within a second tolerance range.

21. The adjustment method of the exposure system as claimed in claim 20, further comprising:
locking a second control unit electrically connected to the second photo detector after the second electric signal is confirmed to be within the second tolerance range, and confirming whether the quality of the first electric signal generated by the first photo detector after receiving the first reflective beam is within the first tolerance range.

22. The adjustment method of the exposure system as claimed in claim 20, wherein the specimen has a plurality of small regions, and the small regions are depressed or protruded small regions.

23. An exposure system, adapted to expose a material, the exposure system comprising:
a laser light source, adapted to emit a laser beam;
a focusing module, comprising a first light converging unit, wherein the first light converging unit is disposed on a transmission path of the laser beam for projecting the laser beam onto the material, the material is adapted to reflect at least a part of the laser beam into a reflective beam, and the first light converging unit is disposed on a transmission path of the reflective beam;
an astigmatism generating element, disposed on a transmission path of the reflective beam from the first light converging unit;
a photo detector, disposed on a transmission path of the reflective beam from the astigmatism generating element, and electrically connected to the focusing module, wherein the photo detector is adapted to detect the reflective beam, and generate an electric signal according to a detecting result, and the focusing module adjusts a distance between the first light converging unit and the material according to the electric signal; and
a grating, disposed on the transmission path of the laser beam, and located between the laser light source and the material, wherein the grating diffracts the laser beam to form multi-order diffraction beams, and at least diffraction beams in the multi-order diffraction beams that have absolute values of order numbers being 0, 1, 2 and 3 cause an exposure reaction of the material.

24. The exposure system as claimed in claim 23, further comprising a control unit, electrically connected to the laser light source, wherein the control unit is adapted to be switched to an exposure mode and a servo mode, an output power of the laser light source corresponding to the exposure mode of the control unit is greater than the output power of the laser light source corresponding to the servo mode of the control unit, and when the control unit is switched to the exposure mode, the laser beam causes a variation of the material, and when the control unit is switched to the servo mode, the photo detector detects the reflective beam, and generates the electric signal according to a detecting result.
